(19) United States
(12) Patent Application Publication
(10) Pub. No.: US 2025/0379399 A1
(43) Pub. Date: Dec. 11, 2025

(54) Electrical Contact Element, Electrical Plug Connector and Electrical Plug Connection

(71) Applicant: Rosenberger Hochfrequenztechnik GmbH & Co. KG, Fridolfing (DE)

(72) Inventors: Nejko Topcagic, Ostermiething (AT); Frank Tatzel, Ostermiething (AT)

(21) Appl. No.: 19/222,082

(22) Filed: May 29, 2025

(30) Foreign Application Priority Data
Jun. 7, 2024 (EP) 24 180 673.6

(51) Int. Cl. H01R 13/62; H01R 13/04; H01R 13/11; H01R 13/627; H01R 103/00

(52) U.S. Cl. CPC H01R 13/6205; H01R 13/04; H01R 13/11; H01R 13/6273; H01R 2103/00

(57) ABSTRACT

An electrical contact element (2, 21) for an electrical plug connector (1), having a magnet arrangement (10, 10′) and an end-face contact portion (11, 11′) which is designed to electrically contact an electrical mating contact element (12) and is movable in a plugging direction(S) between a starting position (P_{A}, P_{A}′) not contacted by the mating contact element (12) and a contacting position (P_{K}, P_{K}′) contacted by the mating contact element (12). The magnet arrangement (10, 10′) is configured to apply a force component (F), directed from the contacting position (P_{K}, P_{K}′) to the starting position (P_{A}, P_{A}′), to the end-face contact portion (11, 11′) by means of magnetic repulsion.

### CROSS-REFERENCE TO RELATED APPLICATIONS

This US National Stage Non-Provisional Utility Patent Application claims priority to earlier filed European Patent Application No. 24 180 673.6 which was filed on Jun. 7, 2024. The entire contents of the identified earlier filed European Patent Application is expressly and fully incorporated herein by this reference.

Pursuant to USPTO rules, this priority claim to earlier filed European Patent Application No. 24 180 673.6 which was filed on June 7. 2024 is also Included in the Application Data Sheet (ADS) filed herewith.

### FIELD OF INVENTION

The invention relates to an electrical contact element for an electrical plug connector, having a magnet arrangement and an end-face contact portion which is designed to electrically contact an electrical mating contact element and is movable in a plugging direction between a starting position not contacted by the mating contact element and a contacting position contacted by the mating contact element.

The Invention moreover relates to an electrical plug connector for connection to an electrical mating plug connector, and to an electrical plug connection having the electrical plug connector and the electrical mating plug connector.

### BACKGROUND OF THE INVENTION

A variety of plug connectors are known in electronic engineering. As is known, electrical plug connectors serve to transmit electrical power and/or data signals to corresponding mating plug connectors. A plug connector or mating plug connector can be, inter alia, a plug, a printed circuit board plug connector, a built-in plug, a socket connector, a coupling or an adapter. The terms “plug connector” and “mating plug connector” used within the scope of the invention are representative of all possible variants.

A plug connection sometimes has to withstand high stresses, for example mechanical vibrational stresses, and also remain closed in a defined fashion even in adverse environmental conditions such that the electrical connection is not Inadvertently broken. It is furthermore generally necessary to ensure that the electrical contacting between the plug connector and the mating plug connector is still possible reliably even in the case of high component tolerances.

In order to meet the requirements mentioned, a contact element formed so that it is spring-loaded in the plugging direction or axial direction is generally used in plug connectors with end-face contacting, as proposed for example in WO 2014/067645 A1. A mechanical spring is, in most cases arranged between two units which can move relative to each other in the plugging direction, In this way, the mating contact element of the mating plug connector allows the contact element of the plug connector to deflect counter to the restoring force of the spring from a starting position Into a contacting position, such that, In the contacted state of the contact element, a sufficient contact pressure can be provided between the contact element and the corresponding mating contact element.

The use of such a spring is, however, not suited for all applications or types of plug connector for structural space reasons. Moreover, the spring is highly mechanically stressed by the permanent stress in the plugged-in state of the plug connection and can consequently be limiting for the lifetime of the plug connector as a whole.

Considering the known prior art, the object of the present invention consists in providing an electrical contact element, for end-face contacting, which ensures reliable contacting in particular even In adverse environmental conditions and/or in the case of high component tolerances, with a preferably compact and long-lasting structure.

The object of the present invention is also to provide an electrical plug connector which ensures reliable contacting in particular even in adverse environmental conditions and/or in the case of high component tolerances, with a preferably compact and long-lasting structure.

The object of the invention is lastly to provide an electrical plug connection which ensures reliable contacting in particular even in adverse environmental conditions and/or in the case of high component tolerances, with a preferably compact and long-lasting structure.

The objects of the present invention are achieved by the invention disclosed and described herein, including the words and terms used in the claims.

The invention relates to an electrical contact element for an electrical plug connector, having a magnet arrangement and an end-face contact portion which is designed to electrically contact an electrical mating contact element. The end-face contact portion is movable in a plugging direction (in particular in an axial direction) between a starting position not contacted by the mating contact element and a contacting position contacted by the mating contact element.

The end-face contact portion is preferably arranged further “forward”, i.e. deflected further in the direction of the mating contact element, in the connection interface provided for the connection to the mating contact element in the starting position than in the contacting position. The mating contact element thus allows the end-face contact portion to move during the contacting from the starting position into the contacting position arranged further “back” in the connection interface.

The end-face contact portion preferably projects into the connection interface in the starting position (in particular in the manner of a contact pin). For example only, and without limitation, the end-face contact portion can project in the starting position from an end face of a separate dielectric (for example only, and without limitation, a housing component or another component of the plug connector) surrounding the end-face contact portion. In the contacting position, the end-face contact portion can preferably be arranged in the same plane as the connection interface or set back (depressed) in the connection interface. It should, however, be emphasized that the end-face contact portion can possibly also be arranged already in the starting position in the same plane as the connection interface or depressed in the connection interface and/or that the end-face contact portion also still projects into the connection interface in the contacting position.

The magnet arrangement is configured to apply a force component, directed from the contacting position to the starting position, to the end-face contact portion by means of magnetic repulsion.

The said force component preferably flows onto the mating contact element in the plugging direction or in the axial direction such that in the non-contacted state the end-face contact portion moves forwards, i.e. in the direction of the mating contact element, in the plug connector.

By virtue of the said magnetic repulsion and the accompanying force component applied to the end-face contact portion, the end-face contact portion can thus be pressed by the magnet arrangement into the starting position. In the non-contacted state or in a state with no separate external forces, the end-face contact portion can be moved by the magnet arrangement into the starting position such that, in the state In which the end-face contact portion is contacted by the mating contact element, a contact pressure or a contact force occurs between the contact element and the mating contact element, as a result of which secure (for example, vibration- and tolerance-proof) contacting is ensured.

The magnet arrangement can advantageously act on the end-face contact portion in a similar manner to a mechanical spring but without the mechanical disadvantages of a mechanical spring such as, for example, the risk of breaking when cyclically stressed or permanently stressed. The proposed contact element can therefore be particularly robust and long-lasting.

It has moreover been shown that a magnet arrangement can be used more flexibly and in a more optimized fashion in terms of structural space as an alternative to a mechanical spring because higher contact forces or greater spring travel can be produced with the same volume than with a mechanical spring arranged in the same volume.

It can be provided that the electrical contact element has at least one first unit having the end-face contact element.

The electrical contact element, or alternatively the plug connector (for example, a housing component of the plug connector) can have a second unit, wherein the first unit is preferably movable in the plugging direction relative to the second unit.

The first unit can be movable in translation and/or rotation relative to the second unit. In particular, the first unit can be telescopable or extendable in the axial direction or at least substantially in the axial direction relative to the second unit. In a less preferred embodiment, an additional or exclusive pivoting movement of the first unit relative to the second unit (for example, by means of a hinge device) can also be provided.

It can be provided that one of the said units is received within an axial end portion in the other unit and its movement is consequently controlled in the other unit.

At least one of the two units is preferably designed as sleeve-shaped, wherein a pin- or rod-shaped or completely cylindrical configuration of at least one of the two units can be provided. Particularly preferably, both units are each designed as sleeve-shaped.

Where both units are each designed as sleeve-shaped, the first unit can be arranged on an end portion of the second unit, for example in the manner of an end cap or closure cap, or vice versa. Tubular units, i.e. units with no closed end face, can, however, also be provided within the scope of the Invention.

Where one of the units is designed as pin- or rod-shaped or completely cylindrical, the said unit can preferably be received in the, in each case, other unit which is designed as sleeve-shaped. Where both units are each designed as pin-shaped or rod-shaped or completely cylindrical, they can be arranged, for example, axially spaced apart from each other in a sleeve-shaped third unit (for example, an electrical conductor or a dielectric) jointly enclosing the two units and which can also be a component, independent of the contact element, of the plug connector itself (such as, for example, a housing component).

It can be provided that the end-face contact portion is spaced further apart from the second unit (in particular with respect to the axial direction but possibly also at a pivot angle) in the starting position than in the contacting position.

The unit pair formed from the two units can, in the starting position, thus be lengthened preferably telescopically relative to the contacting position, as already mentioned. The axial length of the unit pair formed from the two units in the starting position is thus preferably greater than the axial length of the unit pair in the contacting position. The contact element can thus be axially “compressed” in the contacting position compared with the starting position.

The first unit can preferably not be moved from the contacting position beyond the starting position and/or cannot be moved from the starting position beyond the contacting position.

The first unit is preferably movable exclusively in a region between the starting position and the contacting position.

It can be provided in this regard that the first unit has at least one first movement-limiting means and the second unit has at least one corresponding second movement-limiting means.

The first and second movement-limiting means can be, for example, stops (for example, raised portions or steps on the outer and/or Inner cylindrical surface, lateral or radial widened portions, ribs, pins, slots, end faces, flanges, etc.), latching hooks, latching arms, latching depressions or other suitable movement-limiting means for limiting the relative movement of the parts relative to each other. A closed end face of a sleeve-shaped unit and an end face of a pin-shaped, rod-shaped or completely cylindrical unit can be usable as stops.

Particularly preferably, the first movement-limiting means can be designed as a first latching arm and the second movement-limiting means can be designed as a second latching arm which extend in opposite directions and are Interlocked in each other in the assembled state of the two units.

It can be provided that the magnet arrangement has at least one first magnet and one second magnet.

The magnetic pole orientations (i.e. the direction of a notional vector directed from a North pole of the magnet to its South pole) of the first magnet and the second magnet are preferably at least substantially opposed to each other. The same poles of the magnets are thus oriented towards each other (I.e. North-North or South-South) in order to produce the magnetic repulsion between the magnets.

In particular, it can be provided that the magnetic pole orientation is oriented at least substantially in the plugging direction or the axial direction of the contact element.

It should be mentioned at this point that more than the said two magnets can in principle also be provided to form the magnet arrangement. Instead of the first magnet, for example, a group of multiple first magnets can be provided and/or instead of the second magnet, a group of multiple second magnets can be provided, with an in toto opposed magnetic pole orientation in order to produce the repulsion force. Multiple magnet arrangements consisting of In each case two or more magnets can also be provided in principle. The use of a first magnet and a second magnet and precisely one magnet arrangement constitutes only a preferred minimalistic variant of the invention and is not to be understood as limiting.

It can also be provided that a contact element or the magnet arrangement of the contact element within the sense of the present invention also only has a single magnet (In particular the “first” magnet). In this case, the magnetic repulsion can be produced together with a further “second” magnet, independent of the contact element, which is arranged, for example, inside the plug connector at a suitable position and with a suitable orientation. For example, in this way multiple contact elements can “share” a “second” magnet of the plug connector.

It can be provided that the second magnet is arranged coaxially with the first magnet.

A coaxial arrangement of the magnets is not absolutely necessary within the scope of the invention but is generally advantageous in order to maximize the magnetic repulsion force and minimize the structural space.

The first magnet is preferably spaced apart from the second magnet in the plugging direction, at least in the starting position. The magnets can possibly also still be spaced apart from one another in the contacting position of the contact element, wherein the distance between the magnets in the contacting position is, however, preferably reduced compared with the starting position. The magnets can in principle also touch each other in the contacting position and serve, for example, as end stops for a maximum deflection.

The magnets are preferably permanent magnets. They can, however, in principle also be magnetizable or current-carrying bodies. The specific design of the magnets does not necessarily come within the scope of the invention,

It can be provided that the first magnet and/or the second magnet is designed as a bar magnet, ring magnet (polarized axially or radially) or electromagnet.

The use of bar magnets has proved to be particularly advantageous as they can be compact and cost-effective. The use of one or more bar magnets can be suited in particular advantageously for use with a contact element designed as an internal conductor contact element.

However, the use of one or more ring magnets can also advantageously be suitable, in particular for use with a contact element designed as an external conductor contact element.

A combination of ring and bar magnets can also be provided, wherein, for example, a first magnet designed as a bar magnet can be arranged at least partially inside a second magnet designed as a ring magnet, or vice versa.

The use of an electromagnet to form at least one of the two magnets can in particular be advantageous when it is not desired that the magnetic repulsion of the end-face contact portion in the direction of the mating contact element is permanent. The use of the electromagnet can advantageously allow, for example, the electrical contacting to be “decoupled” from the mechanical connection. The electrical contacting can thus take place Intentionally with a time delay from the mechanical connection, or vice versa. It is also possible, for example, for the breaking of the electrical contact specifically to be implemented before the mechanical connection is broken in order to implement, for example, a so-called “interlock function” in a high-voltage plug connector.

The electromagnet, or at least the coil of the electromagnet, can preferably be arranged in an unmovable part of the contact element, in particular in the second unit or at a component of the plug connector which is unmovable (relative to the end-face contact portion), in order to exert a repelling effect, which can be controlled as required, on the end-face contact portion or the (first) unit connected to the end-face contact portion.

It can be provided that the force component applied to the end-face contact portion and directed from the contacting position to the starting position is provided exclusively by the magnetic repulsion of the magnet arrangement.

In particular, it can be provided that the contact element does not have a mechanical spring or other mechanical components for producing the force component. The contact pressure for the contacting and the restoring force for restoring the end-face contact portion into the starting position are thus preferably effected solely by the magnet arrangement.

It can be provided that the end-face contact portion is movement-coupled to the first magnet. The movement of the end-face contact portion thus preferably takes place synchronously with a movement of the first magnet.

In particular, it can be provided that the first magnet is arranged on the first unit. The first magnet can preferably be fastened indirectly or directly on the first unit. In particular, fastening is not absolutely necessary if the first magnet is arranged captively (at least in the axial direction) inside the first unit.

The first magnet can moreover also be formed integrally with the first unit or have the end-face contact portion itself. The first unit can thus be the first magnet. The end-face contact portion can therefore be arranged, for example, on an end face of the first magnet. For this purpose, a permanent magnet with good electrical conductivity can preferably be used, wherein it can, for example, also be provided that the permanent magnet is coated in order to increase the electrical conductivity on its surface.

It can be provided that the second magnet is arranged statically or stationarily or unmovably in the electrical plug connector and the first magnet is arranged movably in the electrical plug connector.

In particular, it can be provided that the second magnet is arranged on the second unit. The second magnet can preferably be fastened indirectly or directly on the second unit (as already mentioned with regard to the first magnet and the first unit, fastening is, however, not absolutely necessary), The second magnet can alternatively also be formed integrally with the second unit or itself form the second unit (and thus, for example, also have or form the “connecting portion” mentioned herein). A permanent magnet with good electrical conductivity (for example only, and without limitation, a coated permanent magnet for increasing the electrical conductivity) can, for example, possibly be used for the second magnet too.

The second magnet and/or the second unit can, for example, be connectable or connected (indirectly or directly) fixedly or unmovably to the electrical plug connector, in particular to a dielectric or plug connector housing of the plug connector.

The magnet arrangement or at least one of the magnets can possibly also be arranged partly or completely outside/independently of the said units, for example can also be connectable or connected indirectly or directly to plug connector components of the plug connector. A compact structure and thus in particular an indirect connection or one-piece design of the first magnet with the first unit and of the second magnet with the second unit is, however, generally preferred.

The first magnet can be arranged inside or outside the first unit (preferably, the first magnet is arranged inside the first unit, for example inside a sleeve-shaped or hollow-cylindrical first unit). The second magnet can be arranged inside or outside the second unit (preferably, the second magnet is arranged inside the second unit, for example inside a sleeve-shaped or hollow-cylindrical second unit).

It can be provided that the end-face contact portion has a contact face and/or a contact tip, However, the end-face contact portion can in principle be designed in any desired fashion (for example, also as a “line contact”, etc.).

In particular when the end-face contact portion is designed as a contact face, the latter can have a plane or flat or curved or conical design (for example, convexly or concavely curved).

It can also be provided in special cases that the contact face is designed as oblique or tilted with respect to the longitudinal axis of the plug connector or to the plugging direction, for example is oriented at an angle to the longitudinal axis of the plug connector by a tilt angle of 20° to 60°, preferably by a tilt angle of 30° to 50°, for example by a tilt angle of 45°,

It can be provided that the contact element has a connecting portion, arranged on an end portion remote from the end-face contact portion, for Indirectly or directly connecting the contact element to an electrical conductor. The connecting portion can be designed, for example only, and without limitation, as a press-fit or crimp portion for connection to an electrical conductor of an electrical cable, as a solder or pin contact for indirect or direct connection to an electrical printed circuit board or as a plug contact (for example, a socket contact or a pin contact) for radially and/or axially contacting a further mating contact element of a further mating plug connector.

The connecting portion of the contact element can be formed Integrally with the first unit or with the second unit (preferred). A one-piece design is, however, not absolutely necessary—in principle, an indirect or direct connection can already be sufficient.

The end-face contact portion of the contact element can preferably be formed integrally with the first unit (preferred) or be connected indirectly or directly to the first unit.

The first unit and/or the second unit (preferably both units) are preferably formed from an electrically conductive material, in particular from a metal. The first unit and/or the second unit can, however, in special cases also be formed partially or completely from an electrically insulating material, for example from a plastic (in this case, the first unit and/or the second unit can, for example, be completely or partially coated in metal or be enclosed at least partially by a sheet-metal part).

As already mentioned, In particular the second unit can also be a component which is independent of the contact element. In this case, the second unit can be a plug connector component (for example, a metal or insulating housing part or a dielectric or other electrical conductor of the plug connector).

As already mentioned herein, it can in particular be provided that the contact element is designed as an internal conductor contact element or as an external conductor contact element.

The invention also relates to an electrical plug connector for connection to an electrical mating plug connector, having at least one electrical contact element according to the embodiments disclosed herein for electrical connection to a mating contact element of the electrical mating plug connector.

One contact element or multiple contact elements of the plug connector can in principle be formed, i.e. can have a magnet arrangement and a corresponding end-face contact portion. It is, however, also possible for “conventional” contact elements to be provided in the proposed plug connector such that only one or some of the contact elements is or are equipped with a magnet arrangement according to the Invention. It is even possible for a mixture of end-face contacting and radial contacting to be provided (for example, by means of laterally movable spring tabs, or even a complete spring cage), wherein preferably only one contact element or multiple contact elements provided for end-face contacting is or are accordingly equipped with a magnet arrangement and the end-face contact portion (for example, an external conductor contact can be formed by a conventional spring cage and one internal conductor contact or multiple internal conductor contacts by end-face contacts equipped according to the Invention with a magnet arrangement).

It should be mentioned at this point that, when multiple contact elements according to the invention are used, it can where appropriate also be provided that a plurality of the contact elements “share” one magnet or multiple magnets or jointly use one magnet or multiple magnets which is or are separate from the contact elements. This means that a magnet arrangement of a contact element, or at least a magnet of the plug connector, can additionally provide or at least strengthen a magnetic repulsion for a second contact element or for multiple further contact elements. In this way, the plug connector can where appropriate be designed more compactly and cost-effectively. Thus, for example: a magnetic pole of a magnet of the plug connector can be positioned axially below the contact elements; or a ring magnet of a contact element (for example, of an external conductor contact element) or of the plug connector at least partially encloses the magnets (in particular bar magnets) of one further contact element or multiple further contact elements, such that all the “first” magnets of the contact elements involved, and thus the respective end-face contact portions, are pressed together into the starting position.

The plug connector is in principle suited for any applications within electronic engineering. Preferred fields of application are, for example, measurement equipment, semiconductor measurement equipment, laboratory equipment, Industrial measurement equipment, sensors, communication equipment, automotive engineering, aeronautical and aerospace engineering and generally signal transmission equipment. The Invention is to be understood as not being limited to use in a specific specialist field.

The plug connector can be, for example only, and without limitation, a coaxial plug connector. The plug connector can have an external conductor contact element and/or one internal conductor contact element or multiple internal conductor contact elements.

The plug connector according to the invention can, inter alia, be a cable plug connector, a printed circuit board plug connector, a housing plug connector, a coupling or a coupler or an adapter.

The invention also relates to an electrical plug connection having an electrical plug connector and the electrical mating plug connector.

In the electrical plug connection, an elastic force component of at least one Internal conductor contact element and/or one external conductor contact element of the plug connector can advantageously be produced by repelling magnetic forces in order to replace a mechanical compression spring. By virtue of the use of magnets to produce the elasticity in the axial or plugging direction instead of a mechanical component, mechanical friction in the plug connector can be reduced and the lifetime of the plug connection increased.

Features which have been described in the context of one of the subjects of the invention, namely provided by the electrical contact element, the electrical plug connector and the electrical plug connection, can advantageously also be implemented for the other subjects of the invention. Likewise, advantages which have been mentioned in the context of one of the subjects of the invention are to be understood as also relating to the other subjects of the invention.

It should additionally be noted that terms such as “comprising”, “having” or “with” do not exclude other features or steps. Moreover, terms such as “a” or “the” which indicate a single step or feature do not exclude multiple features or steps, and vice versa.

Descriptions such as “first” or “second” etc. are used predominantly for reasons of distinguishing between respective device or method features and are not necessarily intended to indicate that features are mutually dependent or are related to one another.

The values and parameters described in the present document include deviations or fluctuations of ±10% or less, preferably ±5% or less, more preferably ±1% or less, and very particularly preferably ±0.1% or less of the value or parameter mentioned in each case, provided that these deviations are not excluded in practice when the Invention is implemented. The specification of ranges by start and end values also comprises all those values and fractions which are included by the range mentioned in each case, in particular the start and end values and a respective mean value.

Exemplary embodiments of the invention will be described below on the basis of the drawings.

### SUMMARY

Our invention generally provides an electrical contact element (2, 21), an electrical plug connector (1) and an electrical plug connection (3).

A principal aspect of the present invention is an electrical contact element (2, 21) for an electrical plug connector (1), having a magnet arrangement (10, 10′) and an end-face contact portion (11, 11′) which is designed to electrically contact an electrical mating contact element (12) and is movable in a plugging direction(S) between a starting position (P_{A}, P_{A}′) not contacted by the mating contact element (12) and a contacting position (P_{K}, P_{K}′) contacted by the mating contact element (12), wherein the magnet arrangement (10, 10′) is configured to apply a force component (F), directed from the contacting position (P_{K}, P_{K}′) to the starting position (P_{A}, P_{A}′), to the end-face contact portion (11, 11′) by means of magnetic repulsion.

A further aspect of the present invention is an electrical contact element (2, 21), characterized in that the electrical contact element (2, 21) has at least one first unit (13, 13′), having the end-face contact portion (11, 11′) and a second unit (14, 14′), wherein the first unit (13, 13′) is movable in the plugging direction(S) relative to the second unit (14, 14′).

A further aspect of the present invention is an electrical contact element (2, 21), characterized in that one of the said units (13, 13′, 14, 14′) is received with an axial end portion and its movement is controlled in the other unit (14, 14′ 13, 13′, wherein the units (13, 13′, 14, 14′) are preferably in each case designed as sleeve-shaped.

A further aspect of the present invention is an electrical contact element (2, 21), characterized in that the end-face contact portion (11, 11′) is spaced further apart from the second unit (14, 14′) in the starting position (P_{A}, P_{A}′) than in the contacting position (P_{K}, P_{K}′), wherein the first unit (13, 13′) and the second unit (14, 14′) are in the starting position (P_{A}, P_{A}′) lengthened preferably telescopically relative to the contacting position (P_{K}, P_{K}′).

A further aspect of the present invention is an electrical contact element (2, 21), characterized in that the first unit (13, 13′) has a first movement-limiting means (16, 16′) and the second unit (14, 14′) has a corresponding second movement-limiting means (17, 17′) such that the first unit (13, 13′) cannot be moved from the contacting position (P_{K}, P_{K}′) beyond the starting position (P_{A}, P_{A}′).

A further aspect of the present invention is an electrical contact element (2, 21), characterized in that the magnet arrangement (10, 10′) has at least one first magnet (18, 18′) and a second magnet (19, 19′), the magnetic pole orientations of which oppose each other at least substantially and are oriented in each case at least substantially in the plugging direction(S) in order to produce the magnetic repulsion.

A further aspect of the present invention is an electrical contact element (2, 21), characterized in that the second magnet (19, 19′) is arranged coaxially with the first magnet (18, 18′) and spaced apart from the first magnet (18, 18′) in the plugging direction (S) at least in the starting position (P_{A}, P_{A}′).

A further aspect of the present invention is an electrical contact element (2, 21), characterized in that the first magnet and/or the second magnet is designed as a bar magnet (18, 19), ring magnet (18′, 19′) or electromagnet (20),

A further aspect of the present invention is an electrical contact element (2, 21), characterized in that the force component (F) applied to the end-face contact portion (11, 11′) and directed from the contacting position (P_{K}, P_{K}′) to the starting position (P_{A}, P_{A}′) is provided exclusively by the magnetic repulsion of the magnet arrangement (10, 10′).

A further aspect of the present invention is an electrical contact element (2, 21), characterized in that the end-face contact portion (11, 11′) is movement-coupled to the first magnet (18, 18′), wherein the first magnet (18, 18′) is preferably arranged on the first unit (13, 13′).

A further aspect of the present invention is an electrical contact element (2, 21), characterized in that the second magnet (19, 19′) is arranged statically or stationarily in the electrical plug connector (1) and the first magnet (18, 18′) is arranged movably in the electrical plug connector (1), wherein the second magnet (19, 19′) is preferably arranged on the second unit (14, 14′),

A further aspect of the present invention is an electrical contact element (2, 21), characterized in that the end-face contact portion (11, 11′) has a contact face or a contact tip.

A further aspect of the present invention is an electrical contact element (2, 21), characterized in that the contact element is designed as an internal conductor contact element (2) or as an external conductor contact element (21).

A still further aspect of the present invention is an electrical plug connector (1) for connection to an electrical mating plug connector (4a), having at least one electrical contact element (2, 21) for electrical connection to a mating contact element (12) of the electrical mating plug connector (4a).

An even still further aspect of the present invention is an electrical plug connection (3), having an electrical plug connector (1) and an electrical mating plug connector (4a).

These and other aspects of the present invention are more fully set forth and disclosed herein.

### BRIEF DESCRIPTIONS OF THE FIGURES

The figures show in each case preferred exemplary embodiments in which individual features of the present Invention are illustrated in combination with one another. Features of an exemplary embodiment can also be Implemented separately from the other features of the same exemplary embodiment and can accordingly be readily combined by a person skilled in the art to form further expedient combinations and sub-combinations with features of other exemplary embodiments

Elements with the same function are provided with the same reference signs in the figures.

FIG. 1 shows schematically an electrical plug connector with an electrical internal conductor contact element.

FIG. 2 shows schematically an enlarged detail of the detail II in FIG. 1.

FIG. 3 shows schematically an electrical plug connection consisting of the electrical plug connector according to FIG. 1 and a mating plug connector plugged into the electrical plug connector.

FIG. 4 shows schematically an electrical plug connector with an electrical internal conductor contact element which has an electromagnet, according to a second exemplary embodiment of the invention.

FIG. 5 shows schematically an electrical plug connection consisting of an electrical plug connector with an electrical internal conductor contact element and an electrical external conductor contact element according to a third exemplary embodiment of the invention, and a mating plug connector, in a first partially plugged-in state.

FIG. 6 shows schematically the electrical plug connection according to FIG. 5 with the mating plug connector in a second partially plugged-in state.

FIG. 7 shows schematically the electrical plug connection according to Figure S with the mating plug connector in a completely plugged-in state.

FIG. 8 shows schematically an electrical plug connector with an electrical internal conductor contact element and an electrical external conductor contact element according to a fourth exemplary embodiment of the invention.

FIG. 9 shows schematically an electrical plug connection consisting of the electrical plug connector according to FIG. 8 and a mating plug connector plugged into the plug connector.

### DETAILED WRITTEN DESCRIPTION OF THE PREFERRED EMBODIMENTS

This disclosure of the invention is submitted in furtherance of the Constitutional purposes of the US Patent Laws “to promote the progress of Science and the useful arts” (Article 1, Section 8).

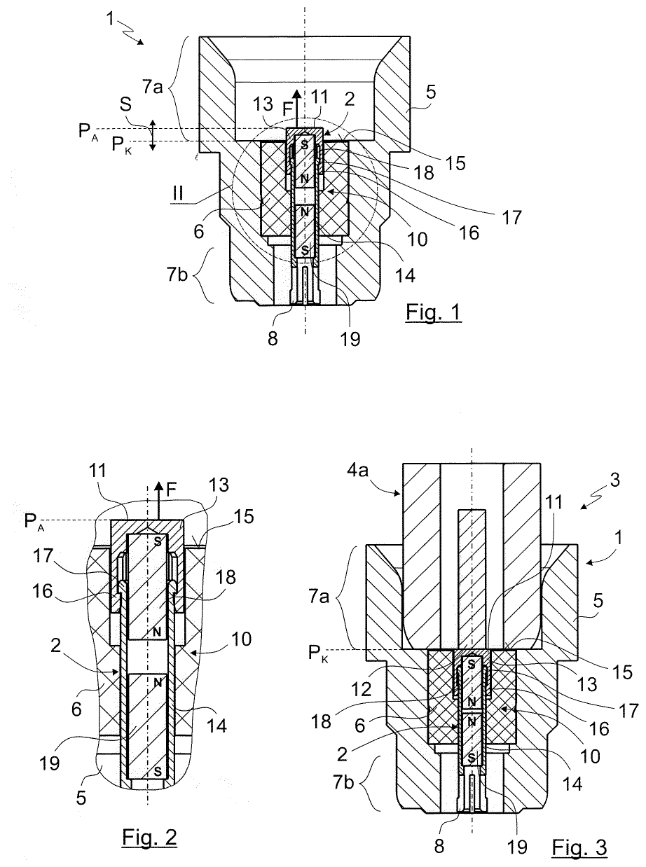

FIG. 1 shows an electrical plug connector 1 with an electrical internal conductor contact element 2 according to a first exemplary embodiment of the invention. FIG. 2 shows an enlarged detail of the detail II in FIG. 1, and FIG. 3 shows the use of the plug connector 1 in an electrical plug connection 3.

The plug connector 1 illustrated in each case in FIGS. 1 to 3 and in the following figures is to be understood purely by way of example and as non-limiting for the invention. The invention can in principle be suited for use with any type of plug connector.

The plug connectors Illustrated in the figures are, for example only. and without limitation, couplers or adapters for providing a connection between a corresponding first mating plug connector 4a and a corresponding second mating plug connector 4b (See in particular FIGS. 5 to 7). The invention can, however, in principle be suitable for any type of plug connector, i.e. in particular also for use with cable plug connectors or printed circuit board plug connectors.

For example, the plug connector 1 is designed as a coaxial plug connector and has an electrically conductive plug connector housing 5 serving as an external conductor. A dielectric 6, in which the internal conductor contact element 2 is arranged, is arranged in a through bore inside the external conductor or plug connector housing 5.

A first connection interface 7a of the plug connector 1 is designed for electrical and mechanical connection to the first mating plug connector 4a, wherein in particular the internal conductor contacting takes place at the end face (See FIG. 3). The plug connector 1 moreover has a second connection interface 7b into which a socket-shaped connecting portion 8 of the internal conductor contact element 2 projects for electrically and mechanically contacting a pin-shaped mating contact element 9 (See inter alia FIG. 5) of the second mating plug connector 4b.

The contact element according to the invention, formed as an internal conductor contact element 2 in the exemplary embodiment of FIGS. 1 to 3, has a magnet arrangement 10 and an end-face contact portion 11 for electrically contacting an electrical mating contact element, formed as an end-face contact element 12, of the first mating plug connector 4a.

The end-face contact portion 11 is movable in a plugging direction S or in an axial direction between a starting position P_{A} not contacted by the mating contact element 12, as indicated in FIG. 1, and a contacting position P_{K} contacted by the mating contact element 12, as also indicated in FIG. 1 and illustrated in FIG. 3.

The end-face contact portion 11 is formed on a first unit 13 which can move in the plugging direction S relative to a second unit 14. The second unit 14 is connected rigidly or unmovably to the dielectric 6, wherein the first unit 13 remains movable together with the end-face contact portion 11 in the plugging direction S.

The first unit 13 with the end-face contact portion 11 is placed onto an axial end portion of the second unit 14 in the manner of an end cap. The first unit 13 thus has, on the side facing the first mating plug connector 4a, a closed end face which can serve simultaneously as an end stop for the contacting position P_{K}. The first and second units 13, 14 are in each case designed as sleeve-shaped. The first unit 13 is movable in translation or telescopically along the outer cylindrical surface of the second unit 14. In the starting position P_{A}, the end-face contact portion 11 is therefore spaced further apart from the second unit 14 than in the contacting position P_{K} (See FIGS. 1 and 3, viewed together).

In the starting position P_{A}, the end-face contact portion 11 projects “forwards” into the first connection interface 7a, i.e. it protrudes axially from an end face 15 of the dielectric 6—this is, however, not absolutely necessary. Above all, the end-face contact portion 11 can move in the plugging direction S.

It is provided within the scope of the invention that a force component F (See FIG. 2) directed from the contacting position P_{K} to the starting position PA is applied to the end-face contact portion 11 by means of magnetic repulsion, i.e. a force component F pointing axially in the direction of the mating plug connector 4a.

So that the first unit 13 thus cannot be moved from the contacting position P_{K} beyond the starting position P_{A} and so that it cannot be separated inadvertently from the second unit 14, the first unit 13 has a first movement-limiting means 16 and the second unit 14 a corresponding second movement-limiting means 17 which are designed in the exemplary embodiments as interlocked latching arms, but this is to be understood as not limiting. The principle of guiding the first unit 13 on the second unit 14 and the movement limitation by the interlocked latching arms can be seen particularly well in the enlarged illustration in FIG. 2.

Because the magnet arrangement 10, by means of the force component F produced by means of magnetic repulsion, causes the end-face contact portion 11 in the plug connector 1 to be moved “forwards”, i.e. towards the first mating plug connector 4a, in the contacted state (See FIG. 3) a contact pressure can be produced which ensures a robust, tolerance-compensating and vibration-proof connection to the first mating contact element 12.

For example, the end-face contact portion 11 is designed in the exemplary embodiments as a plane or flat contact face but which can alternatively also be designed as curved. The use of a contact tip as the end-face contact portion 11 can in principle also be provided.

The magnet arrangement 10 can in principle be designed in any desired fashion and has, In the exemplary embodiment of FIGS. 1 to 3, for example a first magnet 18 and a second magnet 19, the magnetic pole. orientations which oppose each other and are oriented in each case in the plugging direction S in order to produce the said magnetic repulsion. This means that the magnets 18, 19 are oriented relative to each other such that the same magnet poles correspondingly oppose each other (in each case North-North in the exemplary embodiments, wherein alternatively a South-South orientation can also be provided).

The second magnet 19 is arranged coaxially with the first magnet 18 and spaced apart from the first magnet 18 in the plugging direction S at least in the starting position P_{A}. The end-face contact portion 11 is here movement-coupled to the first magnet 18 by the first magnet 18 being arranged in the first unit 13. The first magnet 18 can for this purpose be fastened in the first unit 13, but this is not absolutely necessary. The first magnet 18 can also be movable freely (at least in the axial direction) inside the first unit 13.

Whereas the first magnet 18 or the first unit 13 is axially movable in the plug connector housing 5 or in the dielectric 6, the second magnet 19 is arranged statically, or stationarily, relative to the plug connector housing 5 or to the dielectric 6—and to be precise in the second unit 14 which is fastened rigidly to the electrical plug connector 1 or in the through bore of the dielectric 6.

It should be mentioned at this point that the second magnet 19 can in principle also be positioned outside the internal conductor contact element 2 (the magnet arrangement 10 of the internal conductor contact element 2 can in this case only have the first magnet 18, wherein the second magnet 19 can then be a constituent part of the plug connector 1 or of a further contact element). The embodiment Illustrated is, however, generally preferred because of the particularly compact structure.

In the manner proposed, the force component F directed from the contacting position P_{K} to the starting position P_{A} and applied to the end-face contact portion 11 can be provided comfortably and exclusively by the magnetic repulsion of the magnet arrangement 10, for which reason mechanical friction or other mechanical stresses within the plug connector 1 can be minimized. The lifetime and the maximum number of plugging cycles of the plug connector 1 equipped with the magnet arrangement 10 can consequently be significantly increased compared with a conventional variant with a mechanical spring.

In the case of a contact element designed as an internal conductor contact element 2, as illustrated in FIGS. 1 to 3, it has proven to be particularly suitable if both the first and second units 13, 14 are designed as sleeve-shaped or have at least an axial bore in which the respective first and second magnets 18, 19, which are preferably bar magnets, are received. The magnets 18, 19 can preferably be permanent magnets.

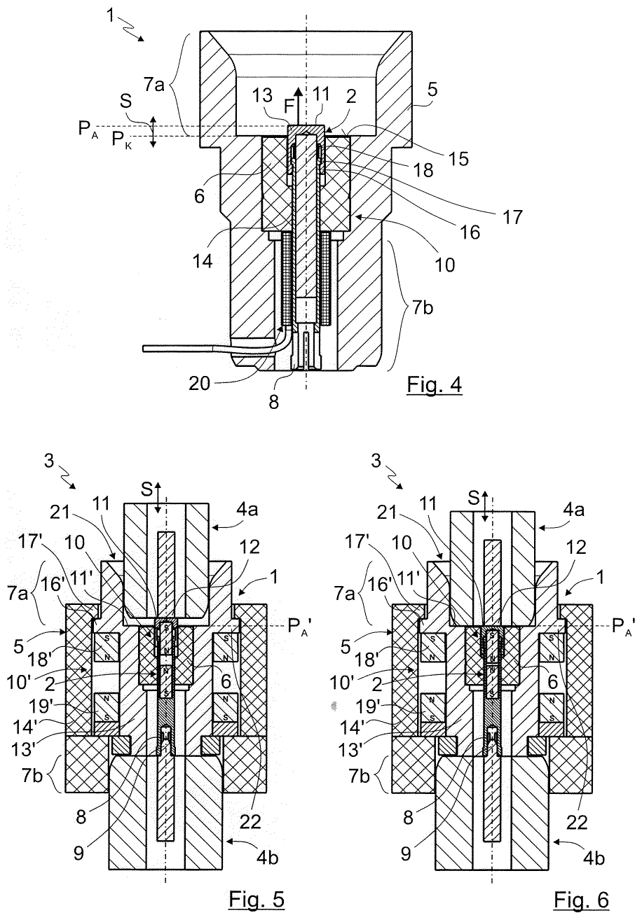

Illustrated by way of example in FIG. 4 is an alternative embodiment of an electrical plug connector 1 with an internal conductor contact element 2, in which the magnet arrangement 10 has an electromagnet 20 by means of which magnetic repulsion of the first unit 13 having the end-face contact portion 11 cannot be produced permanently and instead only as required. In this way, the electrical contacting can be decoupled from the mechanical contacting, which can be advantageous in particular when the plug connector 1 is used as a high-voltage plug connector.

Shown in FIGS. 5 to 7 is an electrical plug connection 3 consisting of an electrical plug connector 1 with an electrical internal conductor contact element 2 and an electrical conductor contact element 21 according to a further exemplary embodiment of the invention. FIGS. 5 to 7 show different plugging states of the first mating plug connector 4a in the first connection interface 7a. A plugged second mating plug connector 4b is indicated by way of example in the second connection interface 7b. A coaxial plug connector 1 is in turn illustrated purely by way of example.

In contrast to the previous exemplary embodiments, the external conductor contact element 21 has a multi-part design and also has a magnet arrangement 10′ and an end-face contact portion 11′ which can be deflected by means of the magnet arrangement 10′. The internal conductor contact element 2 15, for example, designed as already mentioned herein, for which reason the following explanations relate substantially to the external conductor contact element 21 or to the differences between the exemplary embodiments.

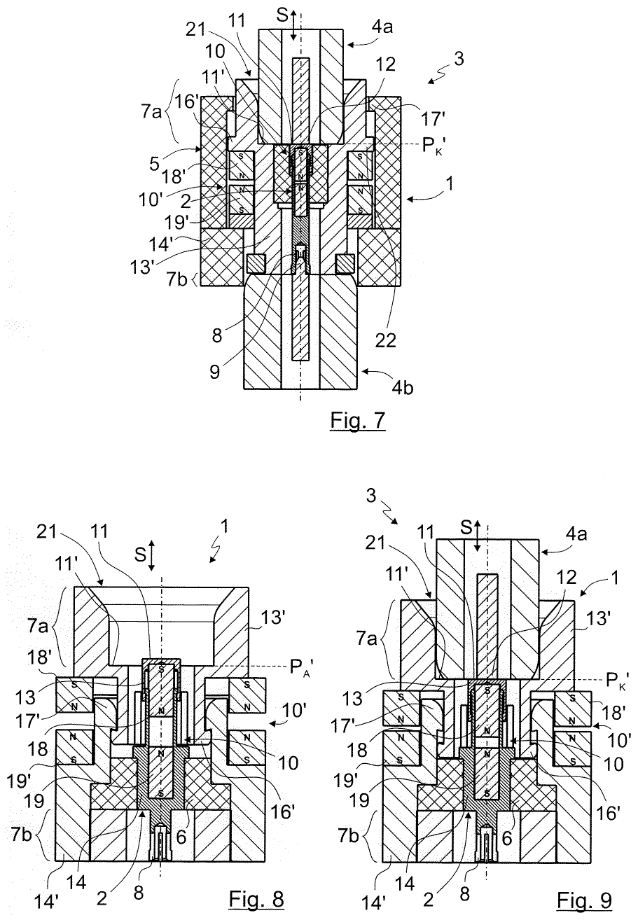

The external conductor contact element 21 then also has a first unit 13′ and a second unit 14′, wherein the first unit 13′ can in turn move in the plugging direction S. The first unit 13′ of the external conductor contact element 21 is for this purpose received inside the second unit 14′ and guided in the plugging direction S. Movement-limiting means 16′, 17′ (reciprocal end stops) are provided to block deflection of the first unit 13′ beyond the starting position P_{A}′. The starting position P_{A}′ of the external conductor contact element 21 is illustrated by way of example in FIGS. 5 and 6 and the completely contacted contacting position P_{K}′ is Illustrated in FIG. 7. FIG. 6 shows a partially plugged state between the electrical plug connector 1 and the first mating plug connector 4a, in which the external conductor contact element 21 has not yet been moved out of its starting position P_{A}′, As is also the case with the internal conductor contact element 2, the first and second units 13′, 14′ of the external conductor contact element 21 in the starting position P_{A}′ are also extended telescopically with respect to the contacting position P_{K}′.

The magnets 18′, 19′ of the magnet arrangement 10′ of the external conductor contact element 21 are, for example, axially polarized ring magnets, wherein a first ring magnet 18 is associated with the first unit 13′ and for this purpose arranged on a flange portion 22 of the first unit 13′ and the second ring magnet 19′ is arranged on the second unit 14′. The first and second ring magnets 18′, 19′ can optionally be fastened to the respective first and second units 13′, 14′.

As can be seen from viewing FIGS. 5 to 7 together, the first unit 13′ of the external conductor contact element 21 is provided in the region of the second connection interface 7b for direct connection to the second mating plug connector 4b, for which reason a deflection of the external conductor contact element 21 from the starting position P_{A}′ into the contacting position P_{K}′ results in an axial deflection of the second connection interface 7b and of the second mating plug connector 4b which may be connected to the second connection interface 7b.

Where a corresponding axial compensating movement of the second connection interface 7b is undesired, the second connection interface 7b can alternatively be arranged on the second unit 14′ of the external conductor contact element 21, as Illustrated on the basis of the exemplary embodiment in FIGS. 8 and 9.

The exemplary embodiment in FIGS. 8 and 9 here corresponds substantially to the exemplary embodiment in FIGS. 5 to 7, wherein the structure of the external conductor contact element 21 is furthermore similar to that of the internal conductor contact element 2. Interlocked latching arms in turn serve as movement-limiting means 16′, 17.

As disclosed herein, the axial compensating movement in the exemplary embodiment in FIGS. 8 and 9 is deliberately restricted solely to the first connection interface 7a, for which reason in this variant an axial deflection in the region of the second connection interface 7b cannot occur (See FIGS. 8 and 9, viewed together).

### Operation

Having described the structure of our electrical contact element. electrical plug connector and electrical plug connection, its operation is briefly described.

A principal object of the present invention is an electrical contact element (2, 21) for an electrical plug connector (1) which is designed to electrically contact an electrical mating contact element (12), the electrical contact element (2, 21) comprising: an end-face contact portion (11, 11′), and the end face contact portion (11, 11′) is movable in a plugging direction (S) between a starting position (P_{A}, P_{A}′) not contacted by the electrical mating contact element (12) and a contacting position (P_{K}, P_{K}′) contacted by the electrical mating contact element (12); and a magnet arrangement (10, 10′) comprising at least one first magnet (18, 18′) and at least one second magnet (19, 19′); and wherein magnetic pole orientations of the at least one first magnet (18, 18′) and the at least one second magnet (19, 19′) substantially oppose each other and the magnetic pole orientations of the at least one first magnet (18, 18′) and the at least one second magnet (19, 19′) are oriented substantially in the plugging direction (S) in order to produce magnetic repulsion; and the magnet arrangement (10, 10′) applies a force component (F) to the end-face contact portion (11, 11′) directed from the contacting position (P_{K}, P_{K}′) to the starting position (P_{A}, P_{A}′), by means of the magnetic repulsion.

A further object of the present invention is an electrical contact element (2, 21) and further comprising: at least one first unit (13, 13′) that defines the end-face contact portion (11, 11′); and at least one second unit (14, 14′); and wherein the at least one first unit (13, 13′) is movable in the plugging direction (S) relative to the at least one second unit (14, 14′).

A further object of the present invention is an electrical contact element (2, 21) wherein an axial end portion of the at least one first unit (13, 13′) and/or an axial end portion of the at least one second unit (14, 14′) is received in the respective other unit (13, 13′, 14, 14′), and movement of the at least one first unit (13, 13′) or movement of the at least one second unit (14, 14′) is controlled in the other unit (14, 14′, 13, 13′); and wherein the at least one first unit (13, 13′) and/or the at least one second unit (14, 14′) is sleeve-shaped.

A further object of the present invention is an electrical contact element (2, 21) wherein the end-face contact portion (11, 11′) is spaced further apart from the at least one second unit (14, 14′) in the starting position (P_{A}, P_{A}′). than in the contacting position (P_{K}, P_{K}′); and wherein the at least one first unit (13, 13′) and the at least one second unit (14, 14′) are, when in the starting position (P_{A}, P_{A}′). lengthened telescopically relative to the contacting position (P_{K}, P_{K}′).

A further object of the present invention is an electrical contact element (2, 21) and further comprising: a first movement-limiting means (16, 16′) carried by the at least one first unit (13, 13′); and a corresponding second movement-limiting means (17, 17′) carried by the at least one second unit (14, 14′); and wherein the first movement-limiting means (16, 16′) and the second movement-limiting means (17, 17′) cooperate so that the at least one first unit (13, 13′) cannot be moved from the contacting position (P_{K}, P_{K}′) beyond the starting position (P_{A}, P_{A}′).

A further object of the present invention is an electrical contact element (2, 21) wherein the at least one second magnet (19, 19′) is coaxial with the at least one first magnet (18, 18′); and the at least one second magnet (19, 19′) is spaced apart from the at least one first magnet (18, 18′) in the plugging direction (S) at least in the starting position (P_{A}, P_{A}′).

A further object of the present invention is an electrical contact element (2, 21) wherein the at least one first magnet and/or the at least one second magnet is a bar magnet (18, 19), or is a ring magnet (18′, 19′), or is an electromagnet (20).

A further object of the present invention is an electrical contact element (2, 21) wherein the force component (F) applied to the end-face contact portion (11, 11′), and directed from the contacting position (P_{K}, P_{K}′) to the starting position (P_{A}, P_{A}′), is provided exclusively by the magnetic repulsion of the magnet arrangement (10, 10′).

A further object of the present invention is an electrical contact element (2, 21) wherein the end-face contact portion (11, 11′) is movement-coupled to the at least one first magnet (18, 18′); and wherein the at least one first magnet (18, 18′) is on the at least one first unit (13, 13′).

A further object of the present invention is an electrical contact element (2, 21) as claimed in claim 2 and wherein the at least one second magnet (19, 19′) is arranged statically or stationarily in the electrical plug connector (1); and the at least one first magnet (18, 18′) is arranged movably in the electrical plug connector (1); and wherein the at least one second magnet (19, 19′) is on the at least one second unit (14, 14′).

A further object of the present invention is an electrical contact element (2, 21) and further comprising: a contact face, or a contact tip, defined by the end-face contact portion (11, 11′).

A further object of the present invention is an electrical contact element (2, 21) wherein the electrical contact element (2, 21) is an internal conductor contact element (2).

A further object of the present invention is an electrical plug connector (1) for connection to an electrical mating plug connector (4a), having at least one electrical contact element (2, 21) for electrical connection to a mating contact element (12) of the electrical mating plug connector (4a), the at least one electrical contact element (2, 21) comprising: an end-face contact portion (11, 11′), and the end-face contact portion (11, 11′) is movable in a plugging direction (S) between a starting position (P_{A}, P_{A}′) not contacted by the electrical mating contact element (12) and a contacting position (P_{K}, P_{K}′) contacted by the electrical mating contact element (12); and a magnet arrangement (10, 10′) comprising at least one first magnet (18, 18′) and at least one second magnet (19, 19′), and wherein magnetic pole orientations of the at least one first magnet (18, 18′) and the at least one second magnet (19. 19′) substantially oppose each other, and the magnetic pole orientations of the at least one first magnet (18, 18′) and the at least one second magnet (19, 19′) are oriented substantially in the plugging direction (S) to produce magnetic repulsion, and the magnet arrangement (10, 10′) applies a force component (F) to the end-face contact portion (11, 11′) directed from the contacting position (P_{K}, P_{K}′) to the starting position (P_{A}, P_{A}′), by means of the magnetic repulsion.

A still further object of the present invention is an electrical plug connector (1) for connection to an electrical mating plug connector (4a), having at least one electrical contact element (2, 21) for electrical connection to a mating contact element (12) of the electrical mating plug connector (4a), the electrical contact element (2, 21) comprising: a magnet arrangement (10, 10′); and an end-face contact portion (11, 11′) which is designed to electrically contact the electrical mating contact element (12); and the end-face contact portion (11, 11′) is movable in a plugging direction (S) between a starting position (P_{A}, P_{A}′) not contacted by the mating contact element (12), and a contacting position (P_{K}, P_{K}′) contacted by the mating contact element (12); and wherein the magnet arrangement (10, 10′) is configured to apply a force component (F) to the end-face contact portion (11, 11′), directed from the contacting position (P_{K}, P_{K}′) to the starting position (P_{A}, P_{A}′), by means of magnetic repulsion: and wherein the magnet arrangement (10, 10′) of the electrical contact element (2, 21) comprises a first magnet (18, 18′) and a second magnet (19, 19′); and wherein the magnetic repulsion is produced by the first magnet (18,18′) and the second magnet (19, 19′), wherein the second magnet (19, 19′) is arranged inside the electrical plug connector (1) independently of the electrical contact element (2, 21).

An even still further object of the present invention is an electrical contact element (2, 21) wherein the electrical contact element (2, 21) is an external conductor contact element (21).

In compliance with the statute, the present invention has been described in language more or less specific, as to structural and methodical features. It is to be understood, however, that the invention is not limited to the specific features shown and described since the means herein disclosed comprise preferred forms of putting the invention into effect. The invention is. therefore, claimed in any of its forms or modifications within the proper scope of the appended claims appropriately interpreted in accordance with the Doctrine of Equivalents.

1. An electrical contact element (2, 21) for an electrical plug connector (1) which is designed to electrically contact an electrical mating contact element (12), the electrical contact element (2, 21) comprising:
an end-face contact portion (11, 11′), and the end face contact portion (11, 11′) is movable in a plugging direction (S) between a starting position (P_{A}, P_{A}′), not contacted by the electrical mating contact element (12) and a contacting position (P_{K}, P_{K}′) contacted by the electrical mating contact element (12); and
a magnet arrangement (10, 10′) comprising at least one first magnet (18, 18′) and at least one second magnet (19, 19′; and wherein
magnetic pole orientations of the at least one first magnet (18, 18′) and the at least one second magnet (19, 19′) substantially oppose each other and the magnetic pole orientations of the at least one first magnet (18, 18′) and the at least one second magnet (19, 19′) are oriented substantially in the plugging direction(S) in order to produce magnetic repulsion; and
the magnet arrangement (10, 10′) applies a force component (F) to the end-face contact portion (11, 11′) directed from the contacting position (P_{K}, P_{K}′) to the starting position (P_{A}, P_{A}′), by means of the magnetic repulsion.

2. The electrical contact element (2, 21) as clamed in claim 1 and further comprising:
at least one first unit (13, 13′) that defines, having the end-face contact portion (11, 11′); and
at least one second unit (14, 14′); and
the at least one first unit (13, 13′) is movable in the plugging direction (S) relative to the at least one second unit (14, 14′).

3. The electrical contact element (2, 21) as claimed in claim 2 and wherein an axial end portion of the at least one first unit (13, 13′) and/or an axial end portion of the at least one second unit (14, 14′) is received in the respective other unit (13, 13′, 14, 14′), and movement of the at least one first unit (13, 13′) or movement of the at least one second unit (14, 14′) is controlled in the other unit (14, 14′, 13, 13′); and wherein;
the at least one first unit (13, 13′) and/or the at least one second unit (14, 14′) is sleeve-shaped.

4. Electrical The electrical contact element (2, 21) as claimed in claim 2 and wherein the end-face contact portion (11, 11′) is spaced further apart from the at least one second unit (14, 14′) in the starting position (P_{A}, P_{A}′) than in the contacting position (P_{K}, P_{K}′); and wherein,
the at least one first unit (13, 13′) and the at least one second unit (14, 14′) are, when in the starting position (P_{A}, P_{A}′), lengthened telescopically relative to the contacting position (P_{K}, P_{K}′).

5. The electrical contact element (2, 21) as claimed in claim 2 and further comprising:
a first movement-limiting means (16, 16′) carried by the at least one first unit (13, 13′); and
a corresponding second movement-limiting means (17, 17′) carried by the at least one second unit (14, 14′); and wherein
the first movement-limiting means (16, 16′) and the second movement-limiting means (17, 17′) cooperate so that the at least one first unit (13, 13′) cannot be moved from the contacting position (P_{K}, P_{K}′) beyond the starting position (P_{A}, P_{A}′).

6. (canceled)

7. The electrical contact element (2, 21) as claimed in claim 1 and wherein the at least one second magnet (19, 19′) is coaxial with the at least one first magnet (18, 18′); and
the at least one second magnet (19, 19′) is spaced apart from the at least one first magnet (18, 18′) in the plugging direction (S) at least in the starting position (P_{A}, P_{A}′).

8. Electrical The electrical contact element (2, 21) as claimed in claim 1 and wherein the at least one first magnet and/or the at least one second magnet is a bar magnet (18, 19), or is a ring magnet (18′, 19′), or is an electromagnet (20).

9. The electrical contact element (2, 21) as claimed in claim 1 and wherein the force component (F) applied to the end-face contact portion (11, 11′), and directed from the contacting position (P_{K}, P_{K}′) to the starting position (P_{A}, P_{A}′), is provided exclusively by the magnetic repulsion of the magnet arrangement (10, 10′).

10. The electrical contact element (2, 21) as claimed in claim 2 and wherein the end-face contact portion (11, 11′) is movement-coupled to the at least one first magnet (18, 18′); and wherein,
the at least one first magnet (18, 18′) is on the at least one first unit (13, 13′).

11. The electrical contact element (2, 21) claimed in claim 2 and wherein
the at least one second magnet (19, 19′) is arranged statically or stationarily in the electrical plug connector (1); and
the at least one first magnet (18, 18′) is arranged movably in the electrical plug connector (1); and wherein
the at least one second magnet (19, 19′) is on the at least one second unit (14, 14′).

12. The electrical contact element (2, 21) as claimed in claim 1 and further comprising:
a contact face, or a contact tip, defined by the end-face contact portion (11, 11′).

13. The electrical contact element (2, 21) as claimed in claim 1 and wherein the electrical contact element (2, 21) is an internal conductor contact element (2).

14. An electrical plug connector (1) for connection to an electrical mating plug connector (4a), having at least one electrical contact element (2, 21) for electrical connection to a mating contact element (12) of the electrical mating plug connector (4a), the at least one electrical contact element (2, 21) comprising:
an end-face contact portion (11, 11′), and the end-face contact portion (11, 11′) is movable in a plugging direction(S) between a starting position (P_{A}, P_{A}′) not contacted by the electrical mating contact element (12) and a contacting position (P_{K}, P_{K}′) contacted by the electrical mating contact element (12); and
a magnet arrangement (10, 10′) comprising at least one first magnet (18, 18′) and at least one second magnet (19 19′), and wherein magnetic pole orientations of the at least one first magnet (18, 18′) and the at least one second magnet (19, 19′) substantially oppose each other, and the magnetic pole orientations of the at least one first magnet (18, 18′) and the at least one second magnet (19, 19′) are oriented substantially in the plugging direction (S) to produce magnetic repulsion, and the magnet arrangement (10, 10′) applies a force component (F) to the end-face contact portion (11, 11′) directed from the contacting position (P_{K}, P_{K}′) to the starting position (P_{A}, P_{A}′), by means of the magnetic repulsion.

15. (canceled)

16. An electrical plug connector (1) for connection to an electrical mating plug connector (4a), having at least one electrical contact element (2, 21) for electrical connection to a mating contact element (12) of the electrical mating plug connector (4a), the electrical contact element (2, 21) comprising:
a magnet arrangement (10, 10′); and
an end-face contact portion (11, 11′) which is designed to electrically contact the electrical mating contact element (12); and
the end-face contact portion (11, 11′) is movable in a plugging direction (S) between a starting position (P_{A}, P_{A}′) not contacted by the mating contact element (12), and a contacting position (P_{K}, P_{K}′) contacted by the mating contact element (12); and wherein
the magnet arrangement (10, 10′) is configured to apply a force component (F) to the end-face contact portion (11, 11′), directed from the contacting position (P_{K}, P_{K}′) to the starting position (P_{A}, P_{A}′), by means of magnetic repulsion; and wherein
the magnet arrangement (10, 10′) of the electrical contact element (2, 21) comprises a first magnet (18, 18′) and a second magnet (19, 19′); and wherein
the magnetic repulsion is produced by the first magnet (18,18′) and the second magnet (19, 19′), wherein the second magnet (19, 19′) is arranged inside the electrical plug connector (1) independently of the electrical contact element (2, 21).

17. The electrical contact element (2, 21) as claimed in claim 1 and wherein the electrical contact element (2, 21) is an external conductor contact element (21).
